(19) United States
(12) Patent Application Publication
(10) Pub. No.: US 2022/0095142 A1
(43) Pub. Date: Mar. 24, 2022

(54) TECHNIQUES FOR ADJACENT CHANNEL INTER-CELL INTERFERENCE COORDINATION VIA CAPABILITY AND MEASUREMENT REPORTING

(71) Applicant: QUALCOMM Incorporated, San Diego, CA (US)

(72) Inventors: Shay Landis, Hod Hasharon (IL); Idan Michael Horn, Hod Hasharon (IL); Assaf Touboul, Netanya (IL); Amit Bar-Or-Tillinger, Tel-Aviv (IL)

(21) Appl. No.: 17/406,350

(22) Filed: Aug. 19, 2021

Related U.S. Application Data
(60) Provisional application No. 63/081,706, filed on Sep. 22, 2020.

(51) Int. Cl. H04W 24/10; H04B 17/336; H04B 17/318

(52) U.S. Cl. CPC H04W 24/10; H04B 17/318; H04B 17/336

(57) ABSTRACT

Methods, systems, and devices for wireless communications are described. A wireless communications system may support inter-band inter-cell interference coordination (ICIC) measurement and capability reporting. For example, a user equipment (UE) may transmit, to a base station, a capability message indicating its ability to use low power signal processing in the absence of inter-band interference and its ability to report values associated with inter-band interference measurement. In addition, the UE may transmit, to the base station, a measurement report indicating values associated with inter-band interference and in response, the base station may update communications with the UE to avoid inter-band interference or the base station may coordinate with other base stations to avoid inter-band interference.

### CROSS REFERENCE

The present Application for Patent claims the benefit of U.S. Provisional Patent Application No. 63/081,706 by Landis et al., entitled “TECHNIQUES FOR ADJACENT CHANNEL INTER-CELL INTERFERENCE COORDINATION VIA CAPABILITY AND MEASUREMENT REPORTING,” filed Sep. 22, 2020, assigned to the assignee hereof, and expressly incorporated by reference herein.

### FIELD OF TECHNOLOGY

The following relates to wireless communications systems, and more specifically to techniques for adjacent channel inter-cell interference coordination (ICIC) via capability and measurement reporting.

### BACKGROUND

Wireless communications systems are widely deployed to provide various types of communication content such as voice, video, packet data, messaging, broadcast, and so on.

These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Some wireless communications systems may support inter-cell interference coordination (ICIC). ICIC may enable base stations to communicate interference information (e.g., a relative narrowband transmission power (RNTP), a high-interference indicator (HII), or an overload indicator (OI), or the like) to other base stations, such that UEs located at a cell edge may avoid interference due to communicating on same time and frequency resources. Some ICIC operations may mitigate intra-band interference. However, these ICIC operations may be unable to handle inter-band interference, which may result in increased power consumption at the UEs.

### SUMMARY

Various aspects of the present disclosure relate to configuring a communication device, such as a UE and a base station, for example, an eNodeB (eNB), a next-generation NodeB or a giga-NodeB (either of which may be referred to as a gNB) of a wireless communication system to support techniques for adjacent channel ICIC UE capability and measurement reporting. For example, a UE may transmit a capability message to a base station indicating a capability for reporting inter-band interference measurements and a capability to utilize low power signal filtering in the absence of inter-band interference. In addition, the UE may transmit a measurement report indicating values associated with inter-band interference. In some examples, the base station may coordinate with other base stations to avoid inter-band interference at the UE based on the measurement report or the base station may update communications with the UE to avoid inter-band interference at the UE based on the measurement report.

A method of wireless communications at a UE is described. The method may include transmitting, to a base station supporting the wireless communications with the UE via a first frequency band, an adjacent channel capability message indicating a capability of the UE to report power levels for an adjacent channel in a second frequency band, receiving, from the base station, an indication to measure power levels in the adjacent channel, measuring adjacent channel interference based on the indication to measure power levels, and transmitting an interference report to the base station indicating the measured adjacent channel interference.

An apparatus for wireless communications is described. The apparatus may include a processor, memory coupled with the processor, and instructions stored in the memory. The instructions may be executable by the processor to cause the apparatus to transmit, to a base station supporting the wireless communications with the apparatus via a first frequency band, an adjacent channel capability message indicating a capability of the apparatus to report power levels for an adjacent channel in a second frequency band, receive, from the base station, an indication to measure power levels in the adjacent channel, measure adjacent channel interference based on the indication to measure power levels, and transmit an interference report to the base station indicating the measured adjacent channel interference.

Another apparatus for wireless communications is described. The apparatus may include means for transmitting, to a base station supporting the wireless communications with the apparatus via a first frequency band, an adjacent channel capability message indicating a capability of the apparatus to report power levels for an adjacent channel in a second frequency band, receiving, from the base station, an indication to measure power levels in the adjacent channel, measuring adjacent channel interference based on the indication to measure power levels, and transmitting an interference report to the base station indicating the measured adjacent channel interference.

A non-transitory computer-readable medium storing code for wireless communications at a UE is described. The code may include instructions executable by a processor to transmit, to a base station supporting the wireless communications with the UE via a first frequency band, an adjacent channel capability message indicating a capability of the UE to report power levels for an adjacent channel in a second frequency band, receive, from the base station, an indication to measure power levels in the adjacent channel, measure adjacent channel interference based on the indication to measure power levels, and transmit an interference report to the base station indicating the measured adjacent channel interference.

Some examples of the method, apparatuses, and non-transitory computer-readable medium described herein may further include operations, features, means, or instructions for determining one or more thresholds associated with adjacent channel interference, measuring adjacent channel interference, and transmitting the interference report based on the measured adjacent channel interference satisfying the one or more thresholds.

Some examples of the method, apparatuses, and non-transitory computer-readable medium described herein may further include operations, features, means, or instructions for receiving, from the base station, a message including the one or more thresholds associated with adjacent channel interference.

In some examples of the method, apparatuses, and non-transitory computer-readable medium described herein, the one or more thresholds may be based on one or more transmission types.

In some examples of the method, apparatuses, and non-transitory computer-readable medium described herein, the one or more transmission types include ultra-reliable low-latency communication (URLLC) or enhanced mobile broadband (eMBB).

Some examples of the method, apparatuses, and non-transitory computer-readable medium described herein may further include operations, features, means, or instructions for receiving, from the base station, a request for the interference report, and transmitting the interference report based on the request.

In some examples of the method, apparatuses, and non-transitory computer-readable medium described herein, the adjacent channel capability message includes a capability of the UE using a first number of analog to digital converter (ADC) bits based on a presence of the adjacent channel interference or using a second number of ADC bits based on an absence of the adjacent channel interference, where the second number of ADC bits may be less than the first number of ADC bits.

In some examples of the method, apparatuses, and non-transitory computer-readable medium described herein, the interference report includes a presence, a location, or a strength, or a combination thereof, associated with the measured adjacent channel interference.

In some examples of the method, apparatuses, and non-transitory computer-readable medium described herein, measuring the adjacent channel interference further may include operations, features, means, or instructions for identifying a Fast Fourier Transform (FFT) operation at the adjacent channel.

A method of wireless communications at a first base station is described. The method may include receiving, from a UE, an adjacent channel capability message indicating a capability of the UE to report power levels for an adjacent channel in a second frequency band different from a first frequency band supported by the first base station, transmitting, to a second base station, a request for the second base station to configure a set of resources for adjacent channel measurements, transmitting, to the UE, an indication to measure power levels in the adjacent channel, and receiving, from the UE, an interference report indicating adjacent channel interference measured by the UE.

A first apparatus for wireless communications is described. The apparatus may include a processor, memory coupled with the processor, and instructions stored in the memory. The instructions may be executable by the processor to cause the first apparatus to receive, from a UE, an adjacent channel capability message indicating a capability of the UE to report power levels for an adjacent channel in a second frequency band different from a first frequency band supported by the first apparatus, transmit, to a second apparatus, a request for the second apparatus to configure a set of resources for adjacent channel measurements, transmit, to the UE, an indication to measure power levels in the adjacent channel, and receive, from the UE, an interference report indicating adjacent channel interference measured by the UE.

Another first apparatus for wireless communications is described. The apparatus may include means for receiving, from a UE, an adjacent channel capability message indicating a capability of the UE to report power levels for an adjacent channel in a second frequency band different from a first frequency band supported by the first apparatus, transmitting, to a second apparatus, a request for the second apparatus to configure a set of resources for adjacent channel measurements, transmitting, to the UE, an indication to measure power levels in the adjacent channel, and receiving, from the UE, an interference report indicating adjacent channel interference measured by the UE.

A non-transitory computer-readable medium storing code for wireless communications at a first base station is described. The code may include instructions executable by a processor to receive, from a UE, an adjacent channel capability message indicating a capability of the UE to report power levels for an adjacent channel in a second frequency band different from a first frequency band supported by the first base station, transmit, to a second base station, a request for the second base station to configure a set of resources for adjacent channel measurements, transmit, to the UE, an indication to measure power levels in the adjacent channel, and receive, from the UE, an interference report indicating adjacent channel interference measured by the UE.

Some examples of the method, apparatuses, and non-transitory computer-readable medium described herein may further include operations, features, means, or instructions for transmitting, to the UE, a message including one or more thresholds associated with adjacent channel interference.

In some examples of the method, apparatuses, and non-transitory computer-readable medium described herein, the one or more thresholds may be based on one or more transmission types.

In some examples of the method, apparatuses, and non-transitory computer-readable medium described herein, the one or more transmission types include URLLC or eMBB.

Some examples of the method, apparatuses, and non-transitory computer-readable medium described herein may further include operations, features, means, or instructions for transmitting, to the UE, a request for the interference report.

In some examples of the method, apparatuses, and non-transitory computer-readable medium described herein, the adjacent channel capability message indicates a capability of the UE using a first number of ADC bits based on a presence of the adjacent channel interference or using a second number of ADC bits based on an absence of the adjacent channel interference, where the second number of ADC bits may be less than the first number of ADC bits.

In some examples of the method, apparatuses, and non-transitory computer-readable medium described herein, the interference report includes a presence, a location, or a strength, or a combination thereof, associated with the measured adjacent channel interference.

Some examples of the method, apparatuses, and non-transitory computer-readable medium described herein may further include operations, features, means, or instructions for identifying a planned transmission configuration in the adjacent channel associated with the second base station, determining an estimated amount of adjacent channel interference associated with the planned transmission configuration, and transmitting, to the UE, a report indicating the estimated amount of adjacent channel interference in a set of slots.

In some examples of the method, apparatuses, and non-transitory computer-readable medium described herein, identifying the planned transmission configuration in the adjacent channel further may include operations, features, means, or instructions for identifying a transmission power, spatial filtering, a resource allocation, or a combination thereof.

Some examples of the method, apparatuses, and non-transitory computer-readable medium described herein may further include operations, features, means, or instructions for transmitting, to the second base station, a request for the second base station to update a planned transmission configuration based on the interference report.

In some examples of the method, apparatuses, and non-transitory computer-readable medium described herein, updating the planned transmission configuration may include operations, features, means, or instructions for allocating a set of resources different from the configured set of resources for adjacent channel measurements.

Some examples of the method, apparatuses, and non-transitory computer-readable medium described herein may further include operations, features, means, or instructions for updating communication with the UE based on the interference report.

### BRIEF DESCRIPTION OF THE DRAWINGS

FIGS. 1 and 2 illustrate examples of wireless communications systems in accordance with aspects of the present disclosure.

FIGS. 3 and 4 illustrate examples of process flows in accordance with aspects of the present disclosure.

FIGS. 5 and 6 show block diagrams of devices in accordance with aspects of the present disclosure.

FIG. 7 shows a block diagram of a UE communications manager in accordance with aspects of the present disclosure.

FIG. 8 shows a diagram of a system including a device in accordance with aspects of the present disclosure.

FIGS. 9 and 10 show block diagrams of devices in accordance with aspects of the present disclosure.

FIG. 11 shows a block diagram of a base station communications manager in accordance with aspects of the present disclosure.

FIG. 12 shows a diagram of a system including a device in accordance with aspects of the present disclosure.

FIGS. 13 and 14 show flowcharts in accordance with aspects of the present disclosure.

### DETAILED DESCRIPTION

A wireless communications system may include communication devices, such as UEs and base stations (e.g., eNBs or gNBs) that may support multiple radio access technologies. Examples of radio access technologies include 4G systems such as LTE systems and 5G systems which may be referred to as NR systems, among other examples. The wireless communications system may support ICIC operations to manage interference between communication devices (e.g., base stations, UEs) in the wireless communication system. For example, an ICIC operation may enable at least two neighboring communication devices (e.g., base stations) to exchange interference information to prevent or reduce interference for another communication device (e.g., a UE) operating at a cell edge.

Some ICIC operations may manage intra-band interference, which may occur when two or more communication devices (e.g., UEs) are located at a cell edge and attempt to use overlapping or partially overlapping time and frequency resources. However, in some cases, some communication devices may experience inter-band interference. A communication device (e.g., a base station) may not have knowledge of a neighboring channel adjacent to a serving channel (e.g., a radio frequency spectrum band (also referred to as a frequency band)) that may be configured for wireless communications with another communication device (e.g., a base station, a UE). For example, a first base station may allocate resources in a first radio frequency spectrum band to a first UE located at a cell edge and a second base station may allocate resources in a second radio frequency spectrum band to a second UE located at or near the first UE (e.g., at the cell edge or within a coverage area of another cell supported by the second base station).

The first radio frequency spectrum band and the second radio frequency spectrum band may be adjacent to one another and the resources allocated to the first UE and the second UE may be located in a channel of the first radio frequency spectrum band that is adjacent to a channel of the second radio frequency spectrum band. If the first UE and the second UE attempt to communicate during a same period, the first UE and the second UE may cause inter-band interference due to the proximity between the channels of the first and second radio frequency spectrum bands or a transmission power of the first UE and the first base station, or the second UE and the second base station. In order to account for the inter-band interference, communication devices (e.g., the first UE and the second UE) may utilize extra analog-to-digit converter (ADC) bits, which may result in added power consumption by the communication device (e.g., the first UE and the second UE). Introduction of an inter-band ICIC framework may avoid inter-band interference experienced by the communication devices. However, some communication devices (e.g., the first UE and the second UE) may not be capable of lowering their power consumption in the case of no inter-band interference (e.g., utilize a lower number of bits). In addition, measurement reporting in regards to inter-band interference has not yet been realized.

Some wireless communications systems may support communication device capability and measurement reporting to account for inter-band interference. In some examples, a base station may establish a connection with a UE and allocate resources to the UE in a first radio frequency spectrum band. The UE may, in some cases, transmit a capability message which indicates the UE's capability to lower power consumption in the event that inter-band interference is mitigated. The capability message may also indicate that the UE is capable of reporting measurement information associated with adjacent channel power levels. In response to the capability message, the base station may mitigate inter-band interference by itself or with the help of neighboring base stations. For example, the base station may receive the capability message from the UE, the UE may transmit an inter-band interference measurement report to the base station, and the base station may update communication with the UE such as to avoid inter-band interference. For example, the base station may allocate different resources to the UE. Alternatively, in response to the capability message, the base station may request that neighboring base stations use a future communication configuration at a specified time and configure the UE to measure the inter-band interference seen during the specified time (e.g., slot N). The UE may report the inter-band interference measurements to the base station and if the inter-band interference measurement report indicates a strong adjacent interference (e.g., above a threshold), the base station may request for the neighboring base stations to adjust their communication configuration at a future slot such that no interference will be present for the UE.

Mitigating inter-band interference may, in some examples, enable digital post distortion (DPoD) operations. DPoD operations are used to account for the effects of non-linearity on a signal when a transmitter utilizes non-linear components such as a high power amplifier which may decrease power consumption at the transmitter. For example, a base station may transmit reference signals to a UE on resources within the serving radio frequency spectrum band and the UE may use these reference signals to estimate the effects of non-linearity using a DPoD algorithm which may involve channel estimation. The UE may then apply this estimation to future transmissions from the base station to account for non-linearity. However, the DPoD algorithm may not account for inter-band channel estimation, and as such, if inter-band interference is present, the UE may estimate the effects of non-linearity incorrectly. However, features of the current disclosure may mitigate inter-band interference at a UE and thus, DPoD operations may be unaffected and enabled.

Aspects of the disclosure are initially described in the context of wireless communications systems. Additional aspects are described in the context of process flows. Aspects of the disclosure are further illustrated by and described with reference to apparatus diagrams, system diagrams, and flowcharts that relate to adjacent channel ICIC UE capability and measurement reporting.

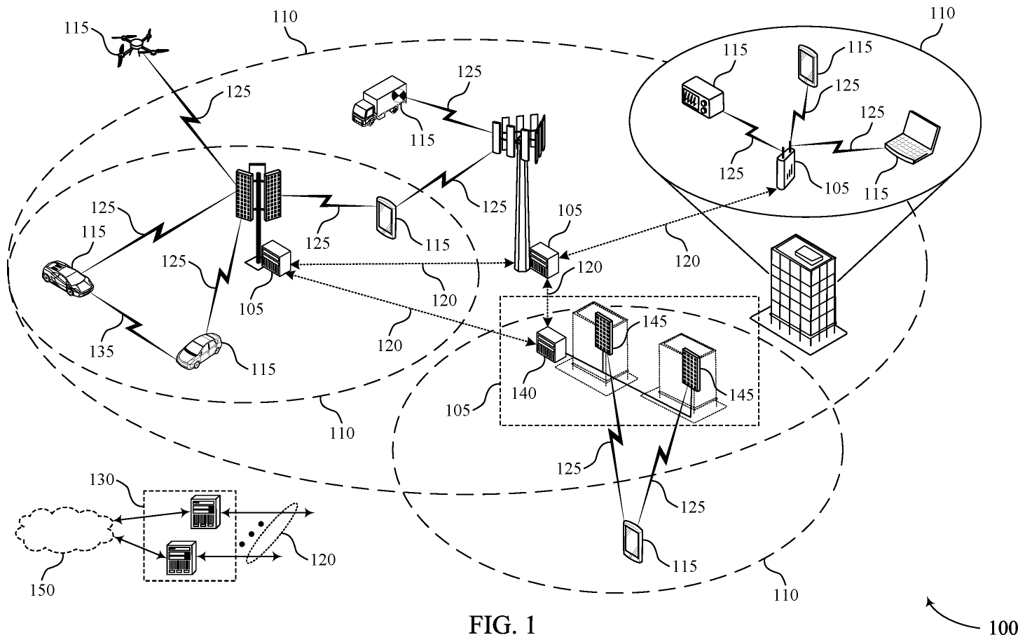

FIG. 1 illustrates an example of a wireless communications system 100 in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode). A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation. A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof For example, the wireless communications system 100 may be configured to support ultra-reliable and low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support UE capability and measurement reporting for inter-band ICIC. For examples, a base station 105 may communicate with a UE 115 at the cell edge using resources located within a first adjacent channel in a first frequency band. The UE 115 may transmit a capability message to the base station indicating its capability of reporting measurements associated with inter-band interference. In addition, the UE 115 may report its capability to utilize low power when processing a signal when no inter-band interference is present. In some examples, the base station 105 may update communication with a UE 115 to avoid inter-band interference at the UE 115. For examples, the UE 115 may transmit an inter-band interference measurement report to the base station and the base station may allocate resources to the UE 115 as to avoid inter-band interference based on the measurement report. Alternatively, the base station may coordinate with other base stations 105 to avoid inter-band interference. For example, the base station 105 may request the other base stations to use a different transmission configuration as to avoid inter-band interference at the UE 115 based on the measurement report.

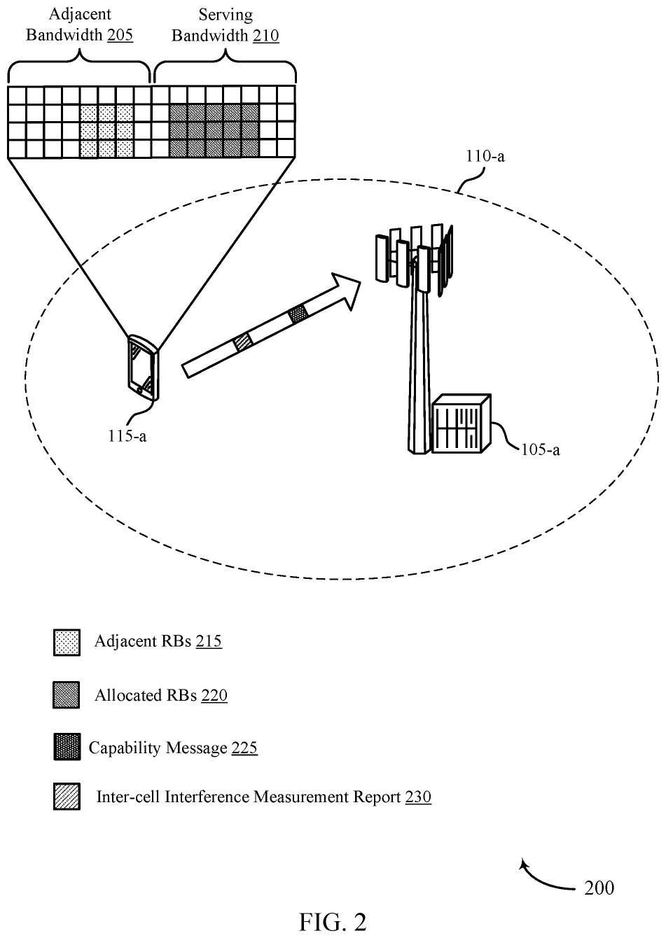

FIG. 2 illustrates an example of a wireless communications system 200 in accordance with aspects of the present disclosure. The wireless communications system 200 may implement aspects of the wireless communications system 100. For example, the wireless communications system 200 may include a base station 105-a and a UE 115-a, which may be examples of a base station 105 and a UE 115 with reference to FIG. 1. In the example of FIG. 2, the base station 105-a may provide a coverage area 110-a over which the base station 105-a and the UE 115-a may perform wireless communications (e.g., downlink and uplinks transmissions). The wireless communications system 200 may support multiple radio access technologies including 4G systems such as LTE systems, LTE-A systems, or LTE-A Pro systems, and 5G systems, which may be referred to as NR systems. The wireless communications system 200 may include features for improvements to power savings and, in some examples, may promote high reliability and low latency wireless communications for power saving, among other benefits.

The wireless communications system 200 may support ICIC operations which may reduce an interference created by two or more cells operating in proximity to one another. ICIC operations may allow a base station to exchange information with other neighboring base stations, such that UEs at a cell edge may communicate more efficiently by reducing the interference between the UEs. For example, the base station 105-a may establish a connection with the UE 115-a and allocate a first set of resources to the UE 115-a within a serving bandwidth 210. In some examples, a neighboring base station may allocate a second set of resources to a neighboring UE (e.g., a UE in close proximity to the UE 115-a) within the serving bandwidth 210, where the second set of resources partially or fully overlap the first set of resources. Additionally, both the UE 115-a and the neighboring UE may be located at the edge of their respective coverage areas. Without ICIC, the UE 115-a and the neighboring UE may experience interference because they may be utilizing the same or at least partially overlapping frequency resources at the same time and may use high transmission power when communicating with the base station 105-a and the neighboring base station. With ICIC, the base station 105-a and the neighboring base station may communicate with each other to gain knowledge on intra-band interference information and allocate resources to the UE 115-a and the neighboring UE in a manner to avoid intra-band interference. For example, the base station 105-a may transmit interference information to the neighboring base station over an X2 interface.

The interference information may include information such as a relative narrowband transmission power (RNTP), a high-interference indicator (HII), an overload indicator (OI), etc. The RNTP may indicate time and frequency resources (e.g., RBs) related to high transmission power for downlink transmissions during the next period of time (e.g., ICIC period). Alternatively, the HII may indicate time and frequency resources related to high transmission power for uplink transmissions during the next period of time. The OI may indicate time and frequency resources related to interference during the last period of time. Using the interference information, the neighboring base stations may allocate resources to the UEs such that intra-band interference is reduced. For example, the neighboring base station may allocate resources to the neighboring UE different from those allocated to the UE 115-a by the base station 105-a.

Some ICIC framework may exclusively manage intra-band interference. That is, the base stations may have knowledge of interference due to other UEs 115 operating within the same frequency band at the cell edge, but may not have knowledge of interference due to the other UEs operating in different radio frequency spectrum bands at the cell edge. Without this knowledge, a base station may communicate with a UE without knowledge that an adjacent channel in a different radio frequency spectrum band may exist. For example, the base station 105-a may communicate with the UE 115-a using allocated RBs 220 in a serving bandwidth 210 and the neighboring base station may communicate with the neighboring UE using adjacent RBs 215 in an adjacent bandwidth 205. The serving bandwidth 210 and the adjacent bandwidth 205 may be examples of 100 MHz bandwidths and may not overlap in frequency. The adjacent RBs 215 may be located in a first channel of the adjacent bandwidth 205 and the allocated RBs may be located in a second channel of the serving bandwidth 210, where the first channel and the second channel are adjacent to one another.

In some examples, if the UE 115-a and the neighboring UE are located at the cell edge respective to the base station 105-a and the neighboring base station, the UE 115-a and the neighboring UE may experience inter-band interference due to receiving or transmitting signals with high power via adjacent frequency bands. The adjacent channel cannot be filtered in analog and may be handled by digital domain filtering. As such, an analog to digital converter (ADC) may see a significant part of the power of the first adjacent channel, resulting in increased power consumption at the UE 115-a and the neighboring UE during times of inter-band interference. That is, extra ADC bits are needed to handle the adjacent channel. Introducing an inter-band ICIC framework may help to mitigate inter-band interference at the UE 115-a, however, some of the UEs 115 may not be capable of operating with a lower number of ADC bits (when compared to the number of bits used to filter the adjacent channel in the event of inter-band interference) in the case of no inter-band interference.

Some wireless communications systems may support capability and measurement reporting mechanisms related to inter-band ICIC. For example, the base station 105-a may establish a connection with the UE 115-a and communicate with the UE 115-a via resources in a first adjacent channel within a serving bandwidth 210 (e.g., allocated RBs 220). In some examples, the UE 115-a may transmit a capability message 225 to the base station 105-a. The capability message 225 may include an indication that the UE 115-a is capable of utilizing the knowledge of no inter-band interference to lower power consumption (e.g., utilize a lower number ADC bits) or the capability message 225 may include an indication that the UE 115-a is capable of reporting inter-band power levels (e.g., amount of interference due to the neighboring base stations 105 utilizing adjacent RBs 215). In some examples, the UE 115-a may transmit the capability message 225 to the base station as part of a connection establishment procedure.

The base station 105-a may avoid inter-band interference at the UE 115-a without coordinating with the neighboring base stations. For example, the base station 105-a may receive the capability message 225 from the UE 115-a. The UE 115-a may monitor for adjacent channel interference (e.g., interference due to neighboring base stations communicating with a cell-edge UE on adjacent RBs 215) and may transmit an inter-cell interference measurement report 230 to the base station 105-a. In some examples, the inter-cell interference measurement report 230 may be requested by the base station 105-a or the inter-cell interference measurement report 230 may be transmitted to the base station 105-a based on one or more triggering events. For example, the UE 115-a may monitor adjacent interference and if a value associated with the adjacent interference (e.g., power determined from a fast Fourier transform (FFT) of adjacent channels (e.g., adjacent RBs 215)) exceeds a threshold, the inter-cell interference measurement report 230 may be transmitted to the base station 105-a.

The base station 105-a may update communications with the UE 115-a based on the inter-cell interference measurement report 230. For example, the base station 105-a may allocate resources to the UE 115-a different from the allocated RBs 220. In some examples, the base station 105-a may allocate resources to the UE 115-a in the serving bandwidth 210, but in a different location than the allocated RBs 220 (e.g., in the center of the serving bandwidth 210 or at the side of the serving bandwidth 210 opposite from adjacent bandwidth 205). Allocating different resources for communication between the UE 115-a and the base station 105-a may enable an environment with low to no adjacent band interference which may reduce power consumption at the UE 115-a. Alternatively, or additionally, in response to capability message 225, the base station 105-a may coordinate with the neighboring base stations to mitigate inter-band interference. For example, the base station 105-a may receive the capability message 225 and transmit a request to the neighboring base stations to use their planned or future configuration (e.g., planned transmissions to UEs at the cell edge) on a specified slot (e.g., slot N).

The base station 105-a may configure the UE 115-a to measure adjacent band interference at the specified slot (e.g., slot N). In some examples, the UE 115-a may measure the inter-band interference power that enters the ADC by looking at an FFT outside of the band (e.g., channels in the adjacent bandwidth 205). The UE 115-a may transmit information including the presence, strength, and location of the adjacent channel interference in an inter-Attorney cell interference measurement report 230 to the base station 105-a. If the inter-cell interference measurement report 230 indicates a strong interference (e.g., above a threshold), the base station 105-a may coordinate with the neighboring base stations to mitigate inter-band interference. For example, the base station 105-a may transmit a request to the neighboring base stations to configure transmission for a future slot (e.g., slot M) such that no interference will be present for the UE 115-a. As such, the base station 105-a may transmit data to the UE 115-a on the allocated RBs 220 where no adjacent interference is to be expected. That is, the base station 105-a may enable an environment in which there is little to no inter-band interference at UE 115-a which may reduce power consumption at UE 115-a in terms of reducing the number of ADC bits needed to process or handle the adjacent channel.

Reducing inter-band interference may also enable DPoD operations. For example, some wireless communications systems may implement different types of radio frequency (RF) operations at a transmitting device. For example, the UE 115-a or the base station 105-a, or both, may utilize a power amplifier to increase the power of a transmitted signal. In some examples, the power amplifier may be an example of a high-power, non-linear power amplifier. That is, the relationship between the input power and the output power of the power amplifier may be non-linear. In some examples, this non-linearity may negatively impact the transmitted signal. For example, one effect of non-linearity on a signal is distortion of the signal waveform.

To mitigate the effects of non-linearity or other pre-transmission impairments, a wireless device (e.g., a receiving device or a transmitting device) may implement DPoD operations may take place at the receiving device (e.g., the base station 105-a or the UE 115-a) and may, for example, mitigate the effects of non-linearity. The DPoD process may be based on pilot signals received from the transmitting device (e.g., may include estimating the effects of non-linearity associated with signals from the transmitting device). That is, the base station 105-a may transmit pilot signals on resources in the serving bandwidth 210, and the UE 115-a, receiving the pilot signals, may perform DPoD processing to mitigate the effects of non-linearity. However, while the base station 105-a may acquire in-band channel (e.g., the serving bandwidth 210) knowledge based on the pilot signaling, the base station 105-a may fail to acquire adjacent channel (e.g., inter-band) knowledge. Without adjacent channel knowledge, the UE 115-a may fail to accurately measure or account for interference in the adjacent regions (e.g., the adjacent bandwidth 205). As a result, the UE 115-a may inaccurately estimate the effects of non-linearity. However, if there is no to little inter-band interference, the UE 115-a may accurately estimate the channel and thus, accurately account for the effects of non-linearity. That is, by enabling no inter-band interference, the base station 105-a may also enable proper DPoD processing which may reduce power consumption at the transmitter (e.g., the base station 105-a).

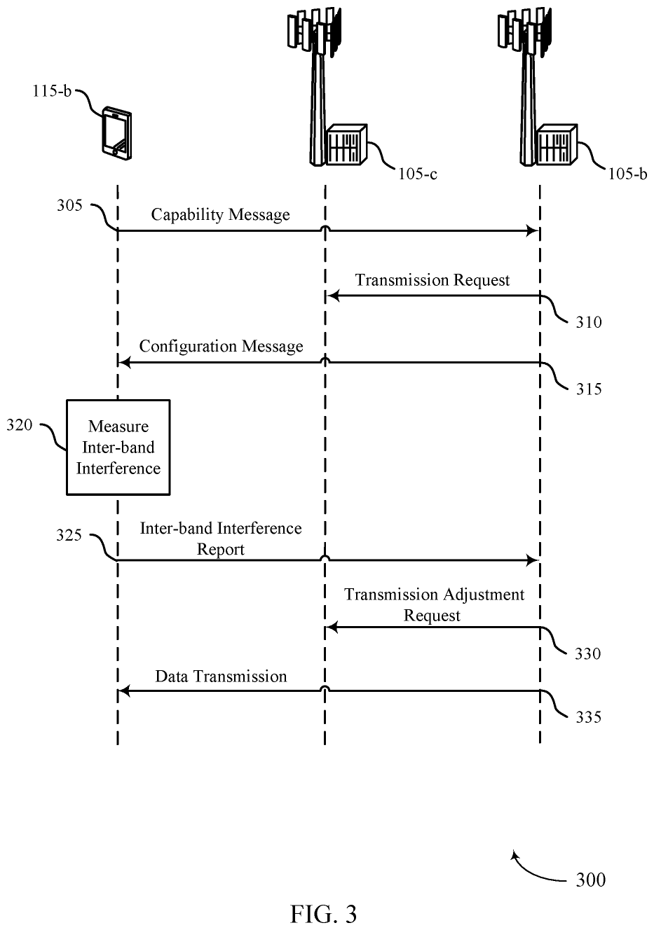

FIG. 3 illustrates an example of a process flow 300 in accordance with aspects of the present disclosure. The process flow 300 may implement aspects of the wireless communications system 100 and the wireless communications system 200 described with reference to FIGS. 1 and 2, respectively. The process flow 300 may be based on a configuration by a base station 105-b or a base station 105-c (e.g., one or more neighboring base stations) and implemented by a UE 115-b to promote power saving for the UE 115-b. For example, in the example of FIG. 3, the UE 115-b may report its capability to reduce a number of ADC bits in the case of no inter-band interference and in response, the base station 105-b may generate an environment with low inter-band interference by coordinating with the base station 105-c. The process flow 300 may also be based on a configuration by the base station 105-b or the base station 105-c and implemented by the UE 115-b to promote high reliability and low latency wireless communications, among other benefits.

In the following description of the process flow 300, the operations between the base stations 105-b, 105-c and the UE 115-b may be transmitted in a different order than the example order shown, or the operations performed by the base stations 105-b, 105-c and the

UE 115-b may be performed in different orders or at different times. Some operations may also be omitted from the process flow 300, and other operations may be added to the process flow 300. The base stations 105-b, 105-c and the UE 115-b may be examples of a base station 105 and a UE 115 as described with reference to FIGS. 1 and 2, respectively.

At 305, the UE 115-b may transmit a capability message to the base station 105-b. The capability message may indicate to the base station 105-b that the UE 115-b is capable of using lower power consumption (e.g., reduced number of ADC bits) when inter-cell interference is eliminated. Alternatively, or additionally, the capability message may indicate that the UE 115-b is capable of measuring and reporting adjacent channel power levels to the base station 105-b.

At 310, the base station 105-b may transmit a transmission request to the base station 105-c. The transmission request may instruct the base station 105-c to use its planned/future communication configurations at a specified time (e.g., slot N). That is, the base station 105-b may configure the base station 105-c to perform a future communication with UEs 115 at the cell edge at a specified time. Additionally, at 315, the base station 105-b may configure the UE 115-b to measure adjacent channel interference (e.g., inter-band interference) at the specified slot (e.g., slot N). In some examples, the base station 105-b may utilize its knowledge of the base station 105-c planned transmissions (e.g., power, spatial filtering, resource allocation) in adjacent bandwidths to estimate the amount of inter-band interference and may report estimated inter-band interference levels in a set of slots to the UE 115-b.

At 320, the UE 115-b may measure the adjacent channel interference levels by identifying an FFT outside of its operating bandwidth (e.g., first adjacent channels of neighboring bandwidths). At 325, the UE 115-b may report the adjacent channel interference to the base station 105-b via an inter-band interference report. The inter-band interference report may include information such as a presence, location (e.g., time and frequency resources), and strength (e.g., power) of the adjacent channel interference. At 330, the base station 105-b may transmit a transmission adjustment request to the base station 105-c (e.g., if the adjacent interference values indicated in the inter-cell inference report indicate high interference (e.g., above a threshold)). The transmission adjustment request may instruct the base station 105-c to adjust communications in a future slot (e.g., M) such that no inter-band interference will be present for UE 115-b at the future slot. Adjusting communication may include the base station 105-c allocating different resources to the UEs 115 located at cell-edge. At 335, the base station 105-b may transmit data to the UE 115-b on resources at slot M.

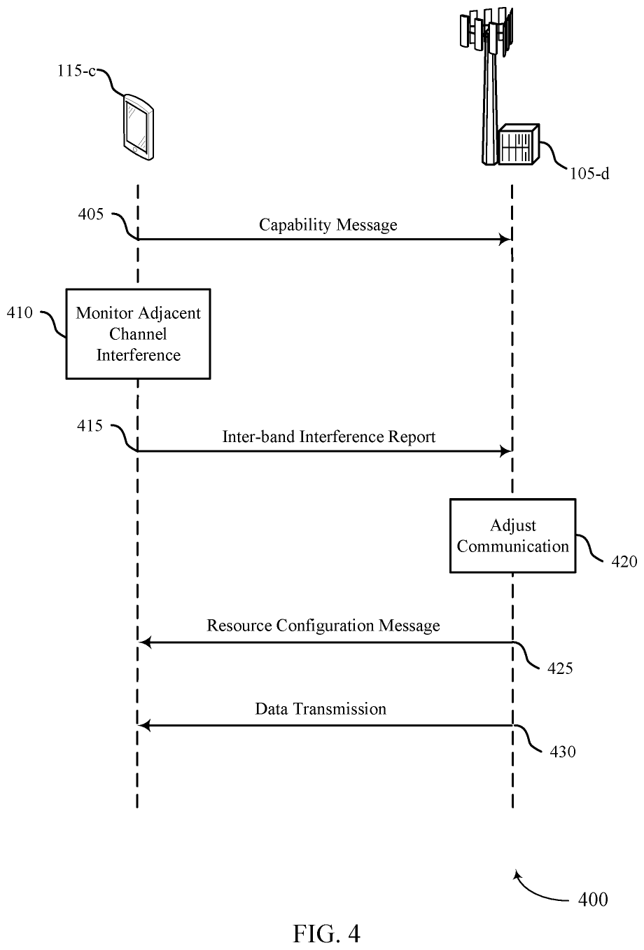

FIG. 4 illustrates an example of a process flow 400 in accordance with aspects of the present disclosure. The process flow 400 may implement aspects of the wireless communications system 100 and the wireless communications system 200 described with reference to FIGS. 1 and 2, respectively. The process flow 400 may be based on a configuration by a base station 105-d and implemented by a UE 115-c to promote power saving for the UE 115-c. The process flow 400 may also be based on a configuration by the base station 105-d and implemented by the UE 115-c to promote high reliability and low latency wireless communications, among other benefits

In the following description of the process flow 400, the operations between the base station 105-d and the UE 115-c may be transmitted in a different order than the example order shown, or the operations performed by the base station 105-d and the UE 115-c may be performed in different orders or at different times. Some operations may also be omitted from the process flow 400, and other operations may be added to the process flow 400. The base station 105-d and the UE 115-c may be examples of a base station 105 and a UE 115 as described with reference to FIGS. 1 and 2, respectively.

At 405, the UE 115-c may transmit a capability message to the base station 105-d. The capability message may indicate to the base station 105-d that the UE 115-c is capable of using lower power consumption (e.g., reduced number of ADC bits) when inter-cell interference is eliminated. Alternatively, or additionally, the capability message may indicate that the UE 115-c is capable of measuring and reporting adjacent interference power levels to the base station 105-d. At 410, the UE 115-c may monitor for inter-band interference (e.g., monitor for a power level associated with inter-band interference).

At 415, the UE 115-c may transmit an inter-band interference report to the base station 105-d. The inter-band interference report may indicate the presence, location, and strength of adjacent channel interference which may be determined by looking at an FFT at adjacent channels (e.g., first adjacent channel of a bandwidth adjacent to a serving bandwidth). In some examples, the base station 105-d may request the inter-band interference report. Alternatively, the inter-band interference report may be transmitted to base station 105-d based on a triggering event. For example, the UE 115-c may continuously monitor the power level of the adjacent channel and the inter-band interference report may be transmitted if the power level associated with the adjacent channel satisfies a threshold. In some examples, there may be multiple triggering events for the inter-band interference report. For example, the power level threshold may be associated with the type of message transmitted (e.g., priority of a message). A higher priority message may have a lower adjacent power level threshold and a lower priority message may have a higher adjacent power level threshold. An example of a high priority message may be a URLLC transmission.

At 420, the base station 105-d may adjust communications with the UE 115-c based on the inter-band interference report received at 415 (e.g., if the inter-band interference is considered high). In some examples, adjusting communication may include allocating resources to the UE 115-c as to avoid inter-band interference. For example, allocating resources for the UE 115-c in a different frequency band than the one used for previous communications with the base station 105-d. Alternatively, the base station 105-c may allocate resources in the same frequency band used for previous communications, but at a different channel location (e.g., a channel that is not located adjacent to a channel utilized by another UE at the cell edge). At 425, the base station 105-d may signal, to the UE 115-c, the communication adjustment via a resource configuration message. At 430, the base station 105-d may transmit a data signal to the UE 115-c on resources determined at 420.

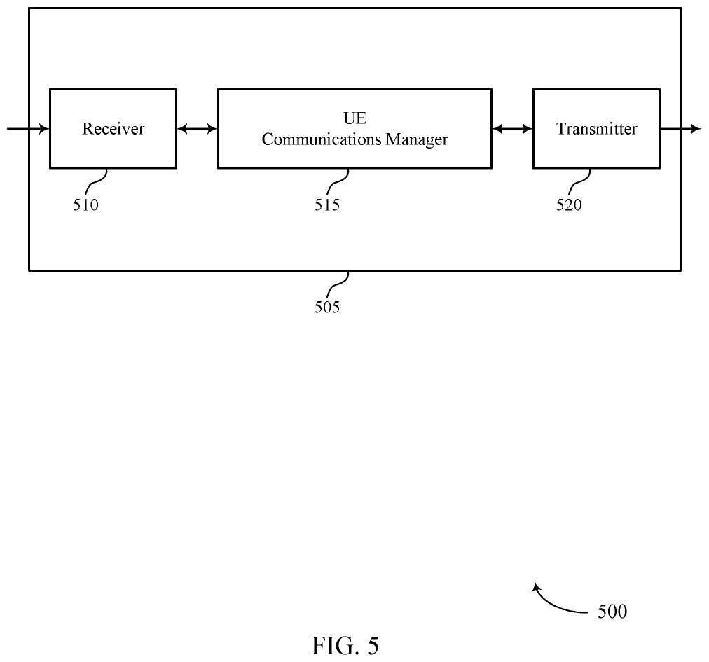

FIG. 5 shows a block diagram 500 of a device 505 in accordance with aspects of the present disclosure. The device 505 may be an example of aspects of a UE 115 as described herein. The device 505 may include a receiver 510, a UE communications manager 515, and a transmitter 520. The device 505 may also include a processor. Each of these components may be in communication with one another (e.g., via one or more buses).

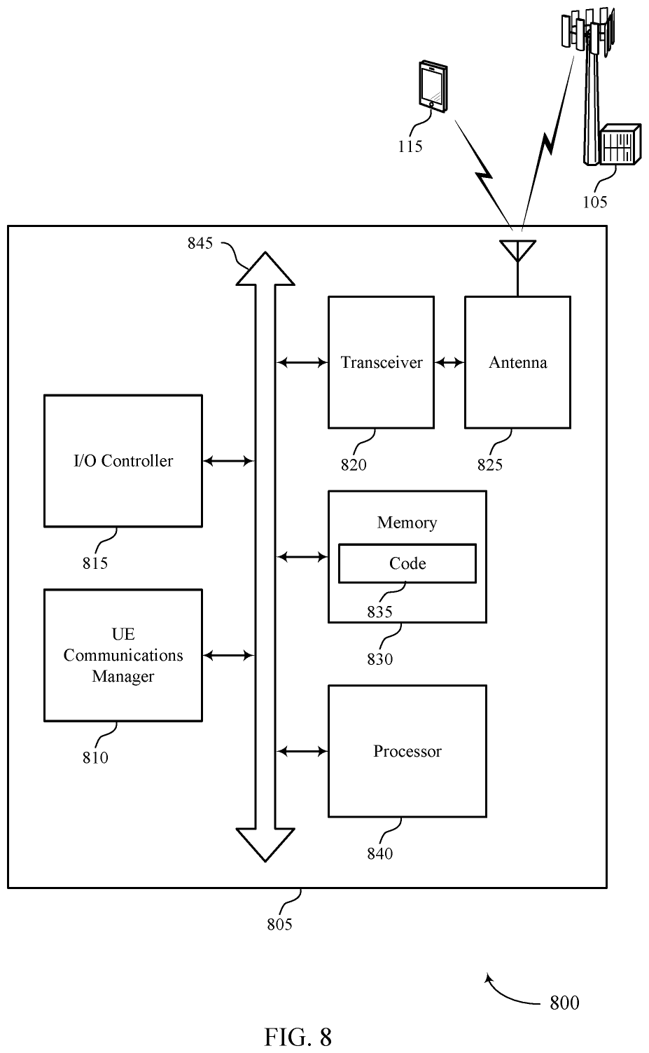

The receiver 510 may receive information such as packets, user data, or control information associated with various information channels (e.g., control channels, data channels, and information related to adjacent channel ICIC UE capability and measurement reporting). Information may be passed on to other components of the device 505. The receiver 510 may be an example of aspects of the transceiver 820 described with reference to FIG. 8. The receiver 510 may utilize a single antenna or a set of antennas.

The UE communications manager 515 may transmit, to a base station supporting the wireless communications with the UE via a first frequency band, an adjacent channel capability message indicating a capability of the UE to report power levels for an adjacent channel in a second frequency band, receive, from the base station, an indication to measure power levels in the adjacent channel, measure adjacent channel interference based on the indication to measure power levels, and transmit an interference report to the base station indicating the measured adjacent channel interference. The UE communications manager 515 may be an example of aspects of the UE communications manager 810 described herein.

The UE communications manager 515 may be implemented as an integrated circuit or chipset for the device 505, and the receiver 510 and the transmitter 520 may be implemented as analog components (for example, amplifiers, filters, antennas) coupled with the device 505 modem to enable wireless transmission and reception. The actions performed by the UE communications manager 515 as described herein may be implemented to realize one or more potential advantages. For example, preventing inter-band interference may allow for an increase in cell coverage. That is, the device 505 (e.g., a UE 115) located at the cell-edge may operate as efficiently the device 505 located near a base station. In addition, some device 505 may experience limited throughput due to strong inter-band interference. By preventing inter-band interference, the device 505 may not experience throughput limitations. In addition, preventing inter-band interference at the device 505 (e.g., a UE) may decrease processing at the device 505. For example, in order to account for inter-band interference, the device 505 may utilize a first amount of ADC bits when receiving a signal. When there is no inter-band interference, the device 505 may utilize a second amount of ADC bits which is less than the first amount of ADC bits. That is, preventing inter-band interference may allow the device 505 to utilize less ADC bits and thus, conserve power and increase battery life.

The UE communications manager 515, or its sub-components, may be implemented in hardware, code (e.g., software or firmware) executed by a processor, or any combination thereof. If implemented in code executed by a processor, the functions of the UE communications manager 515, or its sub-components may be executed by a general-purpose processor, a DSP, an application-specific integrated circuit (ASIC), a field-programmable gate array (FPGA) or other programmable logic device, discrete gate or transistor logic, discrete hardware components, or any combination thereof designed to perform the functions described in the present disclosure.

The UE communications manager 515, or its sub-components, may be physically located at various positions, including being distributed such that portions of functions are implemented at different physical locations by one or more physical components. In some examples, the UE communications manager 515, or its sub-components, may be a separate and distinct component in accordance with various aspects of the present disclosure. In some examples, the UE communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver component. For example, the transmitter 520 may be an example of aspects of the transceiver 820 described with reference to FIG. 8. The transmitter 520 may utilize a single antenna or a set of antennas.

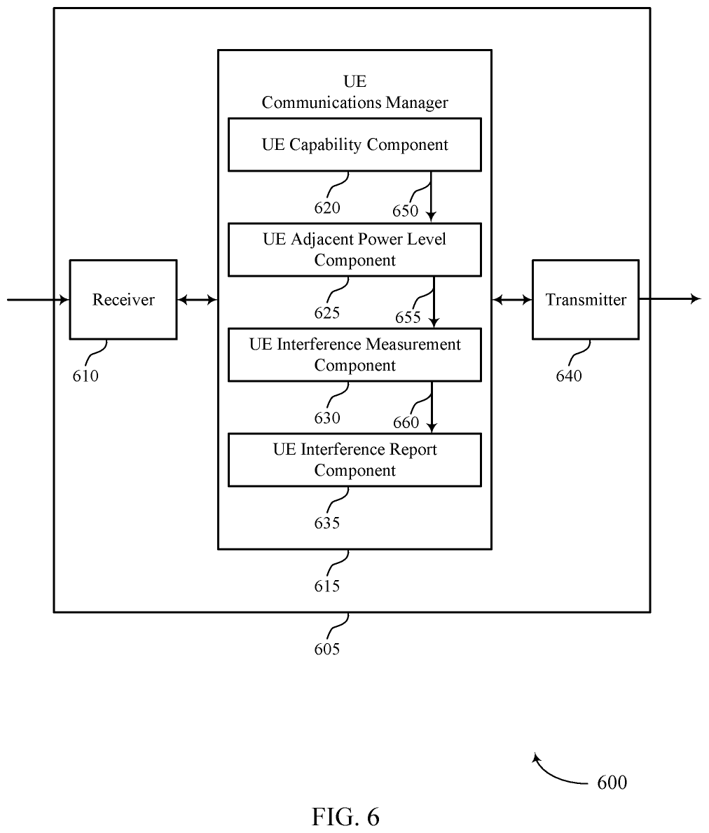

FIG. 6 shows a block diagram 600 of a device 605 in accordance with aspects of the present disclosure. The device 605 may be an example of aspects of a device 505, or a UE 115 as described herein. The device 605 may include a receiver 610, a UE communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to adjacent channel ICIC UE capability and measurement reporting). Information may be passed on to other components of the device 605. The receiver 610 may be an example of aspects of the transceiver 820 described with reference to FIG. 8. The receiver 610 may utilize a single antenna or a set of antennas.

The UE communications manager 615 may be an example of aspects of the UE communications manager 515 as described herein. The UE communications manager 615 may include a UE capability component 620, a UE adjacent power level component 625, a UE interference measurement component 630, and a UE interference report component 635. The UE communications manager 615 may be an example of aspects of the UE communications manager 810 described herein.

The UE capability component 620 may transmit, to a base station supporting the wireless communications with the UE via a first frequency band, an adjacent channel capability message indicating a capability of the UE to report power levels for an adjacent channel in a second frequency band. The UE capability component 620 may send a UE capability signal 650 to the UE adjacent power level component 625. The UE capability signal 650 may include information such as an indication of whether or not the UE is capable of using lower power consumption when inter-cell interference is eliminated or whether or not the UE is capable of measuring and reporting adjacent channel power levels to the base station. The UE adjacent power level component 625 may receive, from the base station, an indication to measure power levels in the adjacent channel. The UE adjacent power level component 625 may send a UE adjacent power level signal 655 to the UE interference measurement component 630. The UE adjacent power level signal 655 may include information such as an indication to initiate adjacent channel interference measurements. The UE interference measurement component 630 may measure adjacent channel interference based on the indication to measure power levels. The UE interference measurement component 630 may send a UE adjacent interference measurement signal 660 to the UE interference report component 635. The UE adjacent interference measurement signal 660 may include information such as an indication of a presence, location, and strength of adjacent channel interference. The UE interference report component 635 may transmit an interference report to the base station indicating the measured adjacent channel interference.

The transmitter 640 may transmit signals generated by other components of the device 605. In some examples, the transmitter 640 may be collocated with a receiver 610 in a transceiver component. For example, the transmitter 640 may be an example of aspects of the transceiver 820 described with reference to FIG. 8. The transmitter 640 may utilize a single antenna or a set of antennas.

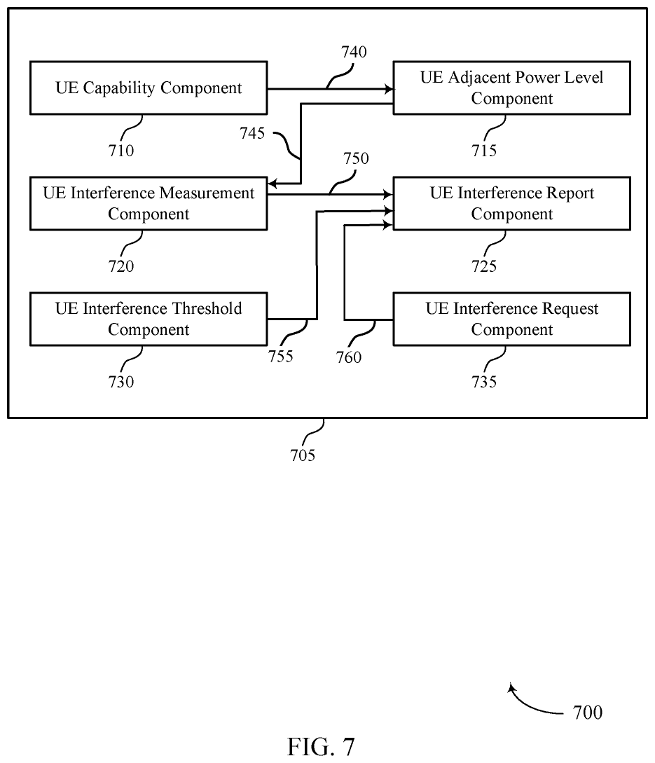

FIG. 7 shows a block diagram 700 of a UE communications manager 705 in accordance with aspects of the present disclosure. The UE communications manager 705 may be an example of aspects of a UE communications manager 515, a UE communications manager 615, or a UE communications manager 810 described herein. The UE communications manager 705 may include a UE capability component 710, a UE adjacent power level component 715, a UE interference measurement component 720, a UE interference report component 725, a UE interference threshold component 730, and a UE interference request component 735. Each of these components may communicate, directly or indirectly, with one another (e.g., via one or more buses).

The UE capability component 710 may transmit, to a base station supporting the wireless communications with the UE via a first frequency band, an adjacent channel capability message indicating a capability of the UE to report power levels for an adjacent channel in a second frequency band. In some cases, the adjacent channel capability message includes a capability of the UE using a first number of ADC bits based on a presence of the adjacent channel interference or using a second number of ADC bits based on an absence of the adjacent channel interference, where the second number of ADC bits is less than the first number of ADC bits. The UE capability component 710 may send a UE capability signal 740 to the UE adjacent power level component 715. The UE capability signal 740 may include information such as an indication of whether or not the UE is capable of using lower power consumption when inter-cell interference is eliminated or whether or not the UE is capable of measuring and reporting adjacent channel power levels to the base station. The UE adjacent power level component 715 may receive, from the base station, an indication to measure power levels in the adjacent channel. The UE adjacent power level component 715 may send a UE adjacent power level signal 745 to the UE interference measurement component 720. The UE adjacent power level signal 745 may include information such as an indication to initiate adjacent channel interference measurements.

The UE interference measurement component 720 may measure adjacent channel interference based on the indication to measure power levels. In some examples, the UE interference measurement component 720 may measure adjacent channel interference. In some examples, the UE interference measurement component 720 may identify an FFT operation at the adjacent channel. The UE interference measurement component 720 may send a UE adjacent interference measurement signal 750 to the UE interference report component 725. The UE adjacent interference measurement signal 750 may include information such as an indication of a presence, location, and strength of adjacent channel interference. The UE interference report component 725 may transmit an interference report to the base station indicating the measured adjacent channel interference. In some examples, the UE interference report component 725 may transmit the interference report based on the measured adjacent channel interference satisfying the one or more thresholds. In some examples, the UE interference report component 725 may transmit the interference report based on the request. In some cases, the interference report includes a presence, a location, or a strength, or a combination thereof, associated with the measured adjacent channel interference.

The UE interference threshold component 730 may determine one or more thresholds associated with adjacent channel interference. In some examples, the UE interference threshold component 730 may receive, from the base station, a message including the one or more thresholds associated with adjacent channel interference. In some cases, the one or more thresholds are based on one or more transmission types. In some cases, the one or more transmission types include URLLC or eMBB. The UE interference threshold component 730 may send a UE interference threshold signal 755 to the UE interference report component 725. The UE interference threshold signal 755 may include information such as threshold values for adjacent channel interference measurements. In some examples, the UE interference report component 725 may generate a report based on the adjacent channel interference measurements exceeding the threshold values. The UE interference request component 735 may receive, from the base station, a request for the interference report. The UE interference request component 735 may send a UE interference request signal 760 to the UE interference report component 725. The UE interference threshold signal 755 may include information such as an indication that the base station requests an adjacent interference measurement report from the UE.

FIG. 8 shows a diagram of a system 800 including a device 805 in accordance with aspects of the present disclosure. The device 805 may be an example of or include the components of device 505, device 605, or a UE 115 as described herein. The device 805 may include components for bi-directional voice and data communications including components for transmitting and receiving communications, including a UE communications manager 810, an I/O controller 815, a transceiver 820, an antenna 825, memory 830, and a processor 840. These components may be in electronic communication via one or more buses (e.g., bus 845).

At least one implementation may enable the UE communications manager 810 to support adjacent channel ICIC capability and measurement reporting. For example, the UE communications manager 810 may transmit, to a base station supporting the wireless communications with the UE via a first frequency band, an adjacent channel capability message indicating a capability of the UE to report power levels for an adjacent channel in a second frequency band. The UE communications manager 810 may receive, from the base station, an indication to measure power levels in the adjacent channel, and measure adjacent channel interference based on the indication to measure power levels. The UE communications manager 810 may transmit an interference report to the base station indicating the measured adjacent channel interference. Based on implementing the adjacent channel ICIC capability and measurement reporting, one or more processors of the device 805 (for example, processor(s) controlling or incorporated with the UE communications manager 810) may promote improvements to power consumption, and, in some examples, may promote enhanced efficiency for high reliability and low latency wireless communications (e.g., downlink and uplink communications), among other benefits.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the device 805 may include a single antenna 825. However, in some cases, the device 805 may have more than one antenna 825, which may be capable of concurrently transmitting or receiving multiple wireless transmissions.

The memory 830 may include random access memory (RAM) and read-only memory (ROM). The memory 830 may store computer-readable, computer-executable code 835 including instructions that, when executed, cause the processor 840 to perform various functions described herein. In some cases, the memory 830 may contain, among other things, a basic input/output system (BIOS) which may control basic hardware or software operation such as the interaction with peripheral components or devices. The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting adjacent channel ICIC UE capability and measurement reporting).

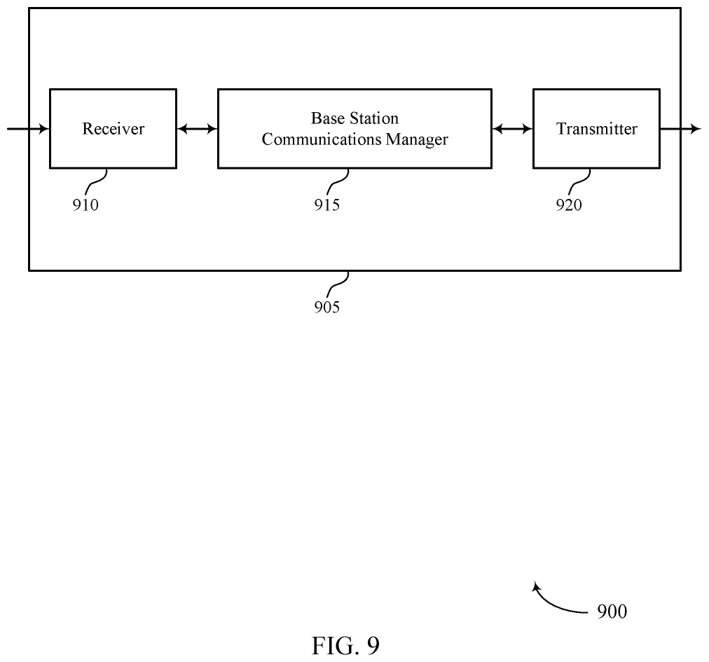

FIG. 9 shows a block diagram 900 of a device 905 in accordance with aspects of the present disclosure. The device 905 may be an example of aspects of a base station 105 as described herein. The device 905 may include a receiver 910, a base station communications manager 915, and a transmitter 920. The device 905 may also include a processor. Each of these components may be in communication with one another (e.g., via one or more buses).

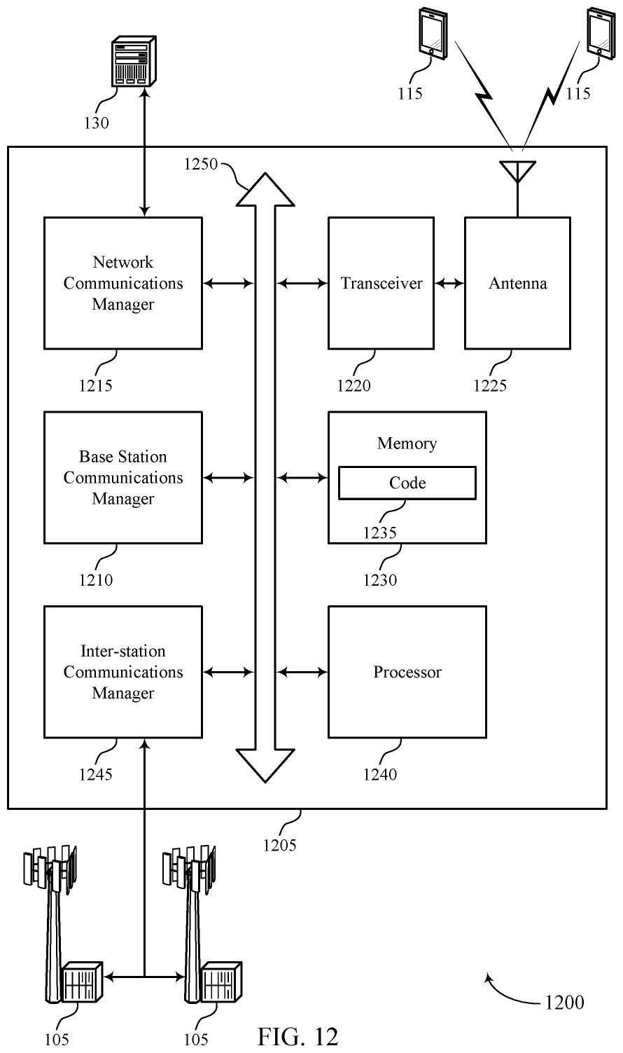

The receiver 910 may receive information such as packets, user data, or control information associated with various information channels (e.g., control channels, data channels, and information related to adjacent channel ICIC UE capability and measurement reporting). Information may be passed on to other components of the device 905. The receiver 910 may be an example of aspects of the transceiver 1220 described with reference to FIG. 12. The receiver 910 may utilize a single antenna or a set of antennas.

The base station communications manager 915 may receive, from a UE, an adjacent channel capability message indicating a capability of the UE to report power levels for an adjacent channel in a second frequency band different from a first frequency band supported by the device 905 (e.g., a first base station). The base station communications manager 915 may transmit, to a second device (e.g., a second base station), a request for the second device to configure a set of resources for adjacent channel measurements. The base station communications manager 915 may transmit, to the UE, an indication to measure power levels in the adjacent channel, and receive, from the UE, an interference report indicating adjacent channel interference measured by the UE. The base station communications manager 915 may be an example of aspects of the base station communications manager 1210 described herein.

The base station communications manager 915, or its sub-components, may be implemented in hardware, code (e.g., software or firmware) executed by a processor, or any combination thereof. If implemented in code executed by a processor, the functions of the base station communications manager 915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The base station communications manager 915, or its sub-components, may be physically located at various positions, including being distributed such that portions of functions are implemented at different physical locations by one or more physical components. In some examples, the base station communications manager 915, or its sub-components, may be a separate and distinct component in accordance with various aspects of the present disclosure. In some examples, the base station communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver component. For example, the transmitter 920 may be an example of aspects of the transceiver 1220 described with reference to FIG. 12. The transmitter 920 may utilize a single antenna or a set of antennas.

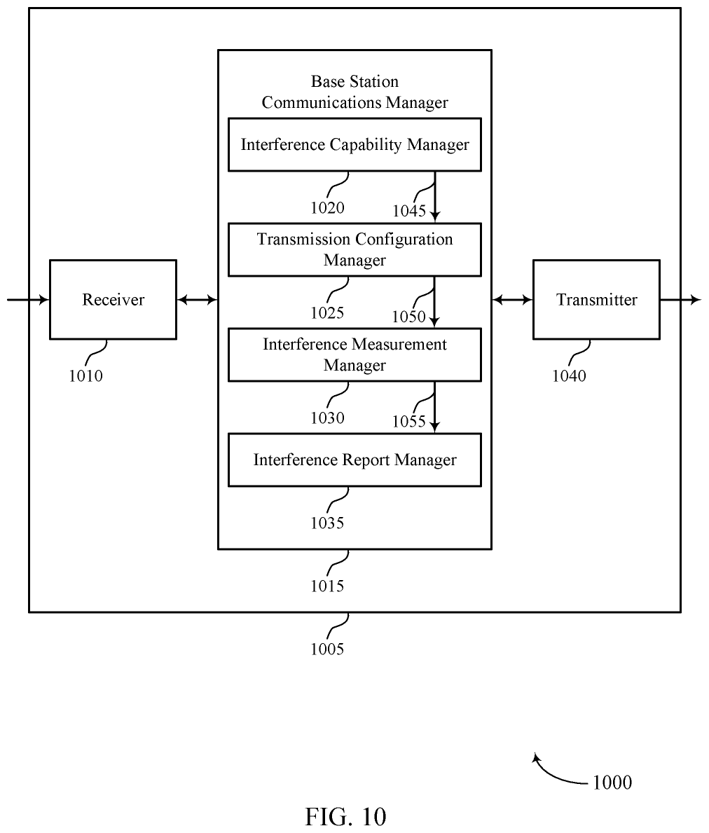

FIG. 10 shows a block diagram 1000 of a device 1005 in accordance with aspects of the present disclosure. The device 1005 may be an example of aspects of a device 905, or a base station 105 as described herein. The device 1005 may include a receiver 1010, a base station communications manager 1015, and a transmitter 1040. The device 1005 may also include a processor. Each of these components may be in communication with one another (e.g., via one or more buses).

The receiver 1010 may receive information such as packets, user data, or control information associated with various information channels (e.g., control channels, data channels, and information related to adjacent channel ICIC UE capability and measurement reporting). Information may be passed on to other components of the device 1005. The receiver 1010 may be an example of aspects of the transceiver 1220 described with reference to FIG. 12. The receiver 1010 may utilize a single antenna or a set of antennas.

The base station communications manager 1015 may be an example of aspects of the base station communications manager 915 as described herein. The base station communications manager 1015 may include an interference capability manager 1020, a transmission configuration manager 1025, an interference measurement manager 1030, and an interference report manager 1035. The base station communications manager 1015 may be an example of aspects of the base station communications manager 1210 described herein.

The interference capability manager 1020 may receive, from a UE, an adjacent channel capability message indicating a capability of the UE to report power levels for an adjacent channel in a second frequency band different from a first frequency band supported by the device 1005 (e.g., a first base station). The interference capability manager 1020 may send an interference capability signal 1045 to the transmission configuration manager 1025. The interference capability signal 1045 may include information such as an indication of whether or not the UE is capable of using lower power consumption when inter-cell interference is eliminated or whether or not the UE is capable of measuring and reporting adjacent channel power levels to the base station. The transmission configuration manager 1025 may transmit, to a second device (e.g., a second base station), a request for the device to configure a set of resources for adjacent channel measurements. The transmission configuration manager 1025 may send a transmission configuration signal 1050 to the interference measurement manager 1030. The transmission configuration signal 1050 may include information such as resources over which adjacent channel interference is to be measured by the UE. The interference measurement manager 1030 may transmit, to the UE, an indication to measure power levels in the adjacent channel. The interference measurement manager 1030 may send an interference measurement signal 1055 to the interference report manager 1035. The interference measurement signal 1055 may include information such as an indication of the power levels that the UE may measure in the adjacent channel. The interference report manager 1035 may receive, from the UE, an interference report indicating adjacent channel interference measured by the UE.

The transmitter 1040 may transmit signals generated by other components of the device 1005. In some examples, the transmitter 1040 may be collocated with a receiver 1010 in a transceiver component. For example, the transmitter 1040 may be an example of aspects of the transceiver 1220 described with reference to FIG. 12. The transmitter 1040 may utilize a single antenna or a set of antennas.

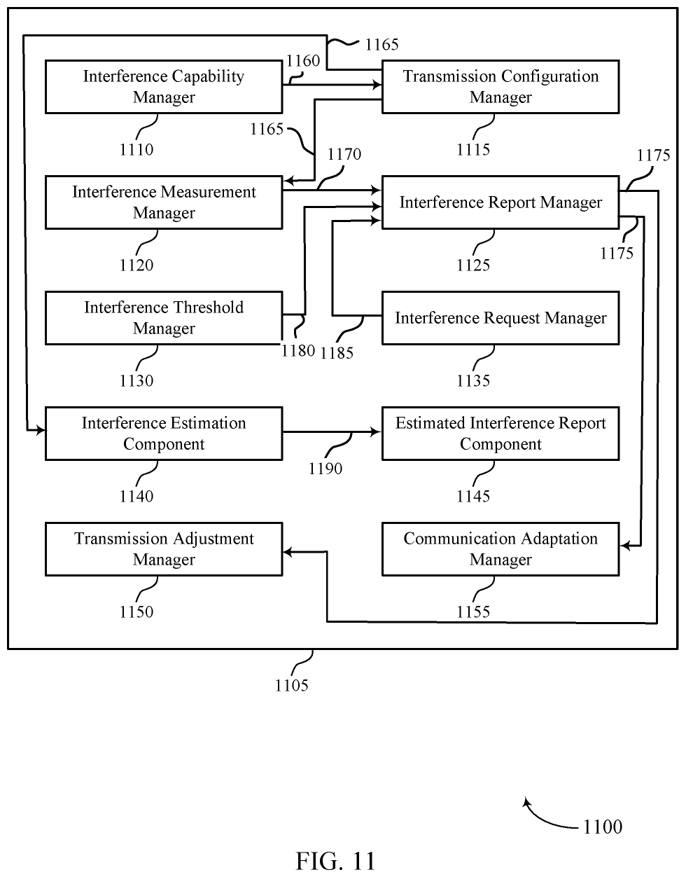

FIG. 11 shows a block diagram 1100 of a base station communications manager 1105 in accordance with aspects of the present disclosure. The base station communications manager 1105 may be an example of aspects of a base station communications manager 915, a base station communications manager 1015, or a base station communications manager 1210 described herein. The base station communications manager 1105 may include an interference capability manager 1110, a transmission configuration manager 1115, an interference measurement manager 1120, an interference report manager 1125, an interference threshold manager 1130, an interference request manager 1135, an interference estimation component 1140, an estimated interference report component 1145, a transmission adjustment manager 1150, and a communication adaptation manager 1155. Each of these components may communicate, directly or indirectly, with one another (e.g., via one or more buses).

The interference capability manager 1110 may receive, from a UE, an adjacent channel capability message indicating a capability of the UE to report power levels for an adjacent channel in a second frequency band different from a first frequency band supported by the first base station. In some cases, the adjacent channel capability message indicates a capability of the UE using a first number of ADC bits based on a presence of the adjacent channel interference or using a second number of ADC bits based on an absence of the adjacent channel interference. The second number of ADC bits is less than the first number of ADC bits. The interference capability manager 1110 may send an interference capability signal 1160 to the transmission configuration manager 1115. The interference capability signal 1160 may include information such as an indication of whether or not the UE is capable of using lower power consumption when inter-cell interference is eliminated or whether or not the UE is capable of measuring and reporting adjacent channel power levels to the base station.

The transmission configuration manager 1115 may transmit, to a second base station, a request for the second base station to configure a set of resources for adjacent channel measurements. In some examples, the transmission configuration manager 1115 may identify a planned transmission configuration in the adjacent channel associated with the second base station. In some examples, the transmission configuration manager 1115 may identify a transmission power, spatial filtering, a resource allocation, or a combination thereof. The transmission configuration manager 1115 may send a transmission configuration signal 1165 to the interference measurement manager 1120 and interference estimation component 1140. The transmission configuration signal 1165 may include information such as an indication of resources over which adjacent channel interference is to be measured by the UE. The interference measurement manager 1120 may transmit, to the UE, an indication to measure power levels in the adjacent channel. The interference measurement manager 1120 may send an interference measurement signal 1170 to the interference report manager 1125. The interference measurement signal 1170 may include information such as an indication of the power levels that the UE may measure in the adjacent channel.

The interference report manager 1125 may receive, from the UE, an interference report indicating adjacent channel interference measured by the UE. In some cases, the interference report includes a presence, a location, or a strength, or a combination thereof, associated with the measured adjacent channel interference. The interference report manager 1125 may send an interference report signal 1175 to the transmission adjustment manager 1150 and the communication adaptation manager 1155. The interference report signal 1175 may include information such as the adjacent interference measurements performed by the UE.

The interference threshold manager 1130 may transmit, to the UE, a message including one or more thresholds associated with adjacent channel interference. In some cases, the one or more thresholds are based on one or more transmission types. In some cases, the one or more transmission types include URLLC or eMBB. The interference threshold manager 1130 may send an interference threshold signal 1180 to the interference report manager 1125. The interference threshold signal 1180 may include information such as an indication of one or more threshold values in which the UE may compare the adjacent interference measurements to. The interference request manager 1135 may transmit, to the UE, a request for the interference report. The interference request manager 1135 may send an interference request signal 1185 to the interference report manager 1125. The interference request signal 1185 may include information such as an indication that the UE is to report adjacent channel measurement values.

The interference estimation component 1140 may determine an estimated amount of adjacent channel interference associated with the planned transmission configuration. The interference estimation component 1140 may send an interference estimation signal 1190 to the estimated interference report component 1145. The interference estimation signal 1190 may include information such as an indication of the estimated adjacent channel interference associated with the planned transmission configuration. The estimated interference report component 1145 may transmit, to the UE, a report indicating the estimated amount of adjacent channel interference in a set of slots. The transmission adjustment manager 1150 may transmit, to the second base station, a request for the second base station to update a planned transmission configuration based on the interference report. In some examples, updating the planned transmission configuration includes allocating a set of resources different from the configured set of resources for adjacent channel measurements. The communication adaptation manager 1155 may update communication with the UE based on the interference report.

FIG. 12 shows a diagram of a system 1200 including a device 1205 in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a base station communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The base station communications manager 1210 may receive, from a UE, an adjacent channel capability message indicating a capability of the UE to report power levels for an adjacent channel in a second frequency band different from a first frequency band supported by the device 1205 (e.g., a first base station). The base station communications manager 1210 may, transmit, to a second device (e.g., a second base station), a request for the second device to configure a set of resources for adjacent channel measurements. The base station communications manager 1210 may transmit, to the UE, an indication to measure power levels in the adjacent channel, and receive, from the UE, an interference report indicating adjacent channel interference measured by the UE.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas. In some cases, the device 1205 may include a single antenna 1225. However, in some cases, the device 1205 may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices. The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting adjacent channel ICIC UE capability and measurement reporting).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

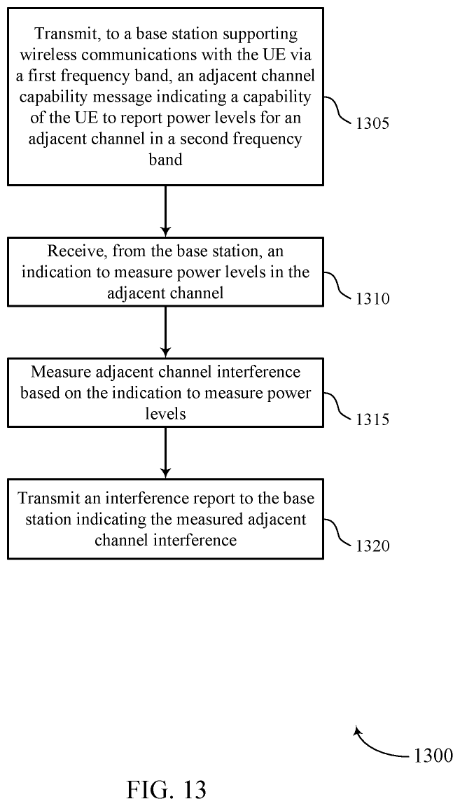

FIG. 13 shows a flowchart illustrating a method 1300 in accordance with aspects of the present disclosure. The operations of method 1300 may be implemented by a UE or its components as described herein. For example, the operations of method 1300 may be performed by a communications manager as described with reference to FIGS. 5 through 8. In some examples, a UE may execute a set of instructions to control the functional elements of the UE to perform the functions described below. Additionally, or alternatively, a UE may perform aspects of the functions described below using special-purpose hardware.

At 1305, the UE may transmit, to a base station supporting wireless communications with the UE via a first frequency band, an adjacent channel capability message indicating a capability of the UE to report power levels for an adjacent channel in a second frequency band. For example, the UE may transmit the channel capability message via a beamformed transmission over a physical control or data channel, such as a physical uplink control channel (PUCCH) or a physical uplink shared channel (PUSCH). In some examples, the UE may determine time and frequency resources over which the physical control or data channel is transmitted. The UE may modulate the beamformed transmission over the determined time and frequency resources, and encode the modulated beamformed transmission. The operations of 1305 may be performed according to the methods described herein. In some examples, aspects of the operations of 1305 may be performed by a UE capability component as described with reference to FIGS. 5 through 8.

At 1310, the UE may receive, from the base station, an indication to measure power levels in the adjacent channel. The UE may receive the indication over a physical control or data channel, such as a physical downlink control channel (PDCCH) or a physical downlink shared channel (PDSCH). In some examples, the UE may determine time and frequency resources over which the physical control or data channel is transmitted. The UE may demodulate the transmission over the determined time and frequency resources, and decode the demodulated transmission to obtain information associated with the indication. The operations of 1310 may be performed according to the methods described herein. In some examples, aspects of the operations of 1310 may be performed by a UE adjacent power level component as described with reference to FIGS. 5 through 8.

At 1315, the UE may measure adjacent channel interference based on the indication to measure power levels. For example, the UE may measure an amount of interference due to the neighboring base stations utilizing adjacent RBs. The operations of 1315 may be performed according to the methods described herein. In some examples, aspects of the operations of 1315 may be performed by a UE interference measurement component as described with reference to FIGS. 5 through 8.

At 1320, the UE may transmit an interference report to the base station indicating the measured adjacent channel interference. For example, the UE may transmit the interference report via a beamformed transmission over a physical control or data channel, such as a PUCCH or a PUSCH. In some examples, the UE may determine time and frequency resources over which the physical control or data channel is transmitted. The UE may modulate the beamformed transmission over the determined time and frequency resources, and encode the modulated beamformed transmissions. The operations of 1320 may be performed according to the methods described herein. In some examples, aspects of the operations of 1320 may be performed by a UE interference report component as described with reference to FIGS. 5 through 8.

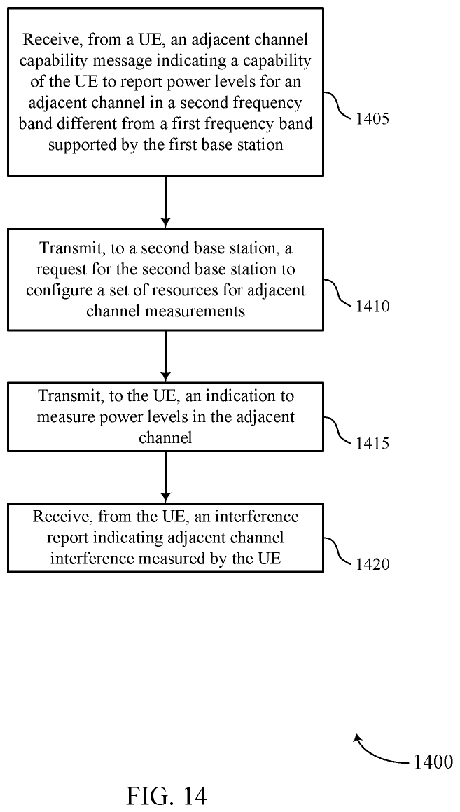

FIG. 14 shows a flowchart illustrating a method 1400 in accordance with aspects of the present disclosure. The operations of method 1400 may be implemented by a base station or its components as described herein. For example, the operations of method 1400 may be performed by a communications manager as described with reference to FIGS. 9 through 12. In some examples, a base station may execute a set of instructions to control the functional elements of the base station to perform the functions described below. Additionally, or alternatively, a base station may perform aspects of the functions described below using special-purpose hardware.

At 1405, the base station may receive, from a UE, an adjacent channel capability message indicating a capability of the UE to report power levels for an adjacent channel in a second frequency band different from a first frequency band supported by the first base station. The base station may receive the adjacent channel capability message over a physical control or data channel, such as a PUCCH or a PUSCH. In some examples, the base station may determine time and frequency resources over which the physical control or data channel is transmitted. The base station may demodulate the transmission over the determined time and frequency resources, and decode the demodulated transmission to obtain information associated with the adjacent channel capability message. The operations of 1405 may be performed according to the methods described herein. In some examples, aspects of the operations of 1405 may be performed by an interference capability manager as described with reference to FIGS. 9 through 12.

At 1410, the base station may transmit, to a second base station, a request for the second base station to configure a set of resources for adjacent channel measurements. For example, the base station may transmit the request via a beamformed transmission over a physical control or data channel, such as a PDCCH or a PDSCH. In some examples, the base station may determine time and frequency resources over which the physical control or data channel is transmitted. The base station may modulate the transmission over the determined time and frequency resources, and encode the modulated beamformed transmission. The operations of 1410 may be performed according to the methods described herein. In some examples, aspects of the operations of 1410 may be performed by a transmission configuration manager as described with reference to FIGS. 9 through 12.

At 1415, the base station may transmit, to the UE, an indication to measure power levels in the adjacent channel. For example, the base station may transmit the indication via a beamformed transmission over a physical control or data channel, such as a PDCCH or a PDSCH. In some examples, the base station may determine time and frequency resources over which the physical control or data channel is transmitted. The base station may modulate the beamformed transmission over the determined time and frequency resources, and encode the modulated beamformed transmissions. The operations of 1415 may be performed according to the methods described herein. In some examples, aspects of the operations of 1415 may be performed by an interference measurement manager as described with reference to FIGS. 9 through 12.

At 1420, the base station may receive, from the UE, an interference report indicating adjacent channel interference measured by the UE. The base station may receive the interference report over a physical control or data channel, such as a PUCCH or a PUSCH. In some examples, the base station may determine time and frequency resources over which the physical control or data channel is transmitted. The base station may demodulate the transmission over the determined time and frequency resources, and decode the transmission to obtain information associated with the report. The operations of 1420 may be performed according to the methods described herein. In some examples, aspects of the operations of 1420 may be performed by an interference report manager as described with reference to FIGS. 9 through 12.

The following provides an overview of aspects of the present disclosure:

Aspect 1: A method for wireless communications at a UE, comprising: transmitting, to a base station supporting the wireless communications with the UE via a first frequency band, an adjacent channel capability message indicating a capability of the UE to report power levels for an adjacent channel in a second frequency band; receiving, from the base station, an indication to measure power levels in the adjacent channel; measuring adjacent channel interference based at least in part on the indication to measure power levels; and transmitting an interference report to the base station indicating the measured adjacent channel interference.

Aspect 2: The method of aspect 1, further comprising: determining one or more thresholds associated with adjacent channel interference; measuring adjacent channel interference; and transmitting the interference report based at least in part on the measured adjacent channel interference satisfying the one or more thresholds.

Aspect 3: The method of aspect 2, further comprising: receiving, from the base station, a message comprising the one or more thresholds associated with adjacent channel interference.

Aspect 4: The method of any of aspects 2 through 3, wherein the one or more thresholds are based on one or more transmission types.

Aspect 5: The method of aspect 4, wherein the one or more transmission types comprise URLLC or eMBB.

Aspect 6: The method of any of aspects 1 through 5, further comprising:

receiving, from the base station, a request for the interference report; and transmitting the interference report based at least in part on the request.

Aspect 7: The method of any of aspects 1 through 6, wherein the adjacent channel capability message comprises a capability of the UE using a first number of ADC bits based at least in part on a presence of the adjacent channel interference or using a second number of ADC bits based at least in part on an absence of the adjacent channel interference, the second number of ADC bits is less than the first number of ADC bits.

Aspect 8: The method of any of aspects 1 through 7, wherein the interference report comprises a presence, a location, or a strength, or a combination thereof, associated with the measured adjacent channel interference.

Aspect 9: The method of any of aspects 1 through 8, wherein measuring the adjacent channel interference further comprises: identifying an FFT operation at the adjacent channel.

Aspect 10: A method for wireless communications at a first base station, comprising: receiving, from a UE, an adjacent channel capability message indicating a capability of the UE to report power levels for an adjacent channel in a second frequency band different from a first frequency band supported by the first base station; transmitting, to a second base station, a request for the second base station to configure a set of resources for adjacent channel measurements; transmitting, to the UE, an indication to measure power levels in the adjacent channel; and receiving, from the UE, an interference report indicating adjacent channel interference measured by the UE.

Aspect 11: The method of aspect 10, further comprising: transmitting, to the UE, a message comprising one or more thresholds associated with adjacent channel interference.

Aspect 12: The method of aspect 11, wherein the one or more thresholds are based on one or more transmission types.

Aspect 13: The method of aspect 12, wherein the one or more transmission types comprise URLLC or eMBB.

Aspect 14: The method of any of aspects 10 through 13, further comprising: transmitting, to the UE, a request for the interference report.

Aspect 15: The method of any of aspects 10 through 14, wherein the adjacent channel capability message indicates a capability of the UE using a first number of ADC bits based at least in part on a presence of the adjacent channel interference or using a second number of ADC bits based at least in part on an absence of the adjacent channel interference, the second number of ADC bits is less than the first number of ADC bits.

Aspect 16: The method of any of aspects 10 through 15, wherein the interference report comprises a presence, a location, or a strength, or a combination thereof, associated with the measured adjacent channel interference.

Aspect 17: The method of any of aspects 10 through 16, further comprising: identifying a planned transmission configuration in the adjacent channel associated with the second base station; determining an estimated amount of adjacent channel interference associated with the planned transmission configuration; and transmitting, to the UE, a report indicating the estimated amount of adjacent channel interference in a set of slots.

Aspect 18: The method of aspect 17, wherein identifying the planned transmission configuration in the adjacent channel further comprises: identifying a transmission power, spatial filtering, a resource allocation, or a combination thereof.

Aspect 19: The method of any of aspects 10 through 18, further comprising: transmitting, to the second base station, a request for the second base station to update a planned transmission configuration based at least in part on the interference report.

Aspect 20: The method of aspect 19, wherein updating the planned transmission configuration comprises: allocating a set of resources different from the configured set of resources for adjacent channel measurements.

Aspect 21: The method of any of aspects 10 through 20, further comprising: updating communication with the UE based at least in part on the interference report.

Aspect 22: An apparatus for wireless communications at a UE, comprising a processor; memory coupled with the processor; and instructions stored in the memory and executable by the processor to cause the apparatus to perform a method of any of aspects 1 through 9.

Aspect 23: An apparatus for wireless communications at a UE, comprising at least one means for performing a method of any of aspects 1 through 9.

Aspect 24: A non-transitory computer-readable medium storing code for wireless communications at a UE, the code comprising instructions executable by a processor to perform a method of any of aspects 1 through 9.

Aspect 25: An apparatus for wireless communications at a first base station, comprising a processor; memory coupled with the processor; and instructions stored in the memory and executable by the processor to cause the apparatus to perform a method of any of aspects 10 through 21.

Aspect 26: An apparatus for wireless communications at a first base station, comprising at least one means for performing a method of any of aspects 10 through 21.

Aspect 27: A non-transitory computer-readable medium storing code for wireless communications at a first base station, the code comprising instructions executable by a processor to perform a method of any of aspects 10 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a digital signal processing (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communications, comprising:
a processor,
memory coupled with the processor; and
instructions stored in the memory and executable by the processor to cause the apparatus to:
transmit, to a base station supporting the wireless communications with the apparatus via a first frequency band, an adjacent channel capability message indicating a capability of the UE to report power levels for an adjacent channel in a second frequency band;
receive, from the base station, an indication to measure power levels in the adjacent channel;
measure adjacent channel interference based at least in part on the indication to measure power levels; and
transmit an interference report to the base station indicating the measured adjacent channel interference.

2. The apparatus of claim 1, wherein the instructions are further executable by the processor to cause the apparatus to:
determine one or more thresholds associated with adjacent channel interference;
measure adjacent channel interference; and
transmit the interference report based at least in part on the measured adjacent channel interference satisfying the one or more thresholds.

3. The apparatus of claim 2, wherein the instructions are further executable by the processor to cause the apparatus to:
receive, from the base station, a message comprising the one or more thresholds associated with the adjacent channel interference.

4. The apparatus of claim 2, wherein the one or more thresholds are based on one or more transmission types.

5. The apparatus of claim 4, wherein the one or more transmission types comprise ultra-reliable and low-latency communications (URLLC) or enhanced mobile broadband (eMBB).

6. The apparatus of claim 1, wherein the instructions are further executable by the processor to cause the apparatus to:
receive, from the base station, a request for the interference report; and
transmit the interference report based at least in part on the request.

7. The apparatus of claim 1, wherein the adjacent channel capability message comprises a capability of the apparatus using a first number of analog to digital (ADC) bits based at least in part on a presence of the adjacent channel interference or using a second number of ADC bits based at least in part on an absence of the adjacent channel interference, wherein the second number of ADC bits is less than the first number of ADC bits.

8. The apparatus of claim 1, wherein the interference report comprises a presence, a location, or a strength, or a combination thereof, associated with the measured adjacent channel interference.

9. The apparatus of claim 1, wherein the instructions to measure the adjacent channel interference further are executable by the processor to cause the apparatus to:
identify a Fast Fourier Transform (FFT) operation at the adjacent channel.

10. The apparatus of claim 1, further comprising:
an antenna panel, a set of antennas, or a transceiver, or a combination thereof

11. An apparatus for wireless communications at a first base station, comprising:
a processor,
memory coupled with the processor; and
instructions stored in the memory and executable by the processor to cause the apparatus to:
receive, from a user equipment (UE), an adjacent channel capability message indicating a capability of the UE to report power levels for an adjacent channel in a second frequency band different from a first frequency band supported by the first base station;
transmit, to a second base station, a request for the second base station to configure a set of resources for adjacent channel measurements;
transmit, to the UE, an indication to measure power levels in the adjacent channel; and
receive, from the UE, an interference report indicating adjacent channel interference measured by the UE.

12. The apparatus of claim 11, wherein the instructions are further executable by the processor to cause the apparatus to:
transmit, to the UE, a message comprising one or more thresholds associated with adjacent channel interference.

13. The apparatus of claim 12, wherein the one or more thresholds are based on one or more transmission types.

14. The apparatus of claim 13, wherein the one or more transmission types comprise ultra-reliable and low latency communications (URLLC) or enhanced mobile broadband (eMBB).

15. The apparatus of claim 11, wherein the instructions are further executable by the processor to cause the apparatus to:
transmit, to the UE, a request for the interference report.

16. The apparatus of claim 11, wherein the adjacent channel capability message indicates a capability of the UE using a first number of analog to digital (ADC) bits based at least in part on a presence of the adjacent channel interference or using a second number of ADC bits based at least in part on an absence of the adjacent channel interference, wherein the second number of ADC bits is less than the first number of ADC bits.

17. The apparatus of claim 11, wherein the interference report comprises a presence, a location, or a strength, or a combination thereof, associated with the measured adjacent channel interference.

18. The apparatus of claim 11, wherein the instructions are further executable by the processor to cause the apparatus to:
identify a planned transmission configuration in the adjacent channel associated with the second base station;
determine an estimated amount of adjacent channel interference associated with the planned transmission configuration; and
transmit, to the UE, a report indicating the estimated amount of adjacent channel interference in a set of slots.

19. The apparatus of claim 18, wherein the instructions to identify the planned transmission configuration in the adjacent channel further are executable by the processor to cause the apparatus to:
identify a transmission power, spatial filtering, a resource allocation, or a combination thereof.

20. The apparatus of claim 11, wherein the instructions are further executable by the processor to cause the apparatus to:
transmit, to the second base station, a request for the second base station to update a planned transmission configuration based at least in part on the interference report.

21. The apparatus of claim 20, wherein the instructions to update the planned transmission configuration are executable by the processor to cause the apparatus to allocate a set of resources different from the configured set of resources for adjacent channel measurements.

22. The apparatus of claim 11, wherein the instructions are further executable by the processor to cause the apparatus to:
update communication with the UE based at least in part on the interference report.

23. The apparatus of claim 11, further comprising:
an antenna panel, a set of antennas, or a transceiver, or a combination thereof.

24. A method for wireless communications at a user equipment (UE), comprising:
transmitting, to a base station supporting the wireless communications with the UE via a first frequency band, an adjacent channel capability message indicating a capability of the UE to report power levels for an adjacent channel in a second frequency band;
receiving, from the base station, an indication to measure power levels in the adjacent channel;
measuring adjacent channel interference based at least in part on the indication to measure power levels; and
transmitting an interference report to the base station indicating the measured adjacent channel interference.

25. The method of claim 24, further comprising:
determining one or more thresholds associated with the adjacent channel interference;
measuring adjacent channel interference; and
transmitting the interference report based at least in part on the measured adjacent channel interference satisfying the one or more thresholds.

26. The method of claim 25, further comprising:
receiving, from the base station, a message comprising the one or more thresholds associated with adjacent channel interference.

27. The method of claim 24, further comprising:
receiving, from the base station, a request for the interference report; and
transmitting the interference report based at least in part on the request.

28. A method for wireless communications at a first base station, comprising:
receiving, from a user equipment (UE), an adjacent channel capability message indicating a capability of the UE to report power levels for an adjacent channel in a second frequency band different from a first frequency band supported by the first base station;
transmitting, to a second base station, a request for the second base station to configure a set of resources for adjacent channel measurements;
transmitting, to the UE, an indication to measure power levels in the adjacent channel; and
receiving, from the UE, an interference report indicating adjacent channel interference measured by the UE.

29. The method of claim 28, further comprising:
transmitting, to the UE, a message comprising one or more thresholds associated with adjacent channel interference.

30. The method of claim 28, further comprising:
transmitting, to the UE, a request for the interference report.
